(19) United States
(12) Patent Application Publication
(10) Pub. No.: US 2024/0378002 A1
(43) Pub. Date: Nov. 14, 2024

(54) PRINTING APPARATUS

(71) Applicant: CANON KABUSHIKI KAISHA, Tokyo (JP)

(72) Inventor: RYUJI NAGAHARA, Kanagawa (JP)

(21) Appl. No.: 18/776,875

(22) Filed: Jul. 18, 2024

Related U.S. Application Data
(63) Continuation of application No. PCT/JP2022/048448, filed on Dec. 28, 2022.

(30) Foreign Application Priority Data
Jan. 20, 2022 (JP) 2022-006863

(51) Int. Cl. G06F 3/12

(52) U.S. Cl. CPC G06F 3/1238; G06F 3/1222; G06F 3/1259

(57) ABSTRACT

When a printing apparatus receives a print request having an Internet Printing Protocol (IPP)-based format including a privacy attribute value from a client terminal, the printing apparatus performs access control on a print job based on a privacy attribute value of the print job.

### CROSS-REFERENCE TO RELATED APPLICATIONS

This application is a Continuation of International Patent Application No. PCT/JP2022/048448, filed Dec. 28, 2022, which claims the benefit of Japanese Patent Application No. 2022-006863, filed Jan. 20, 2022, both of which are hereby incorporated by reference herein in their entirety.

### BACKGROUND OF THE INVENTION

### Field of the Invention

The present invention relates to a printing apparatus for receiving a print job from an external apparatus.

### Background Art

There has been widely used a technique for entering a print job from a client terminal to a printing apparatus and hiding a print data attribute item according to a privacy level specified in the print job (see Patent Literature 1). In such a printing system, a user performs privacy setting by using a vendor driver of the printing apparatus from the client terminal and then performs printing. The printing apparatus sets access control on attribute items based on a specified privacy setting and stores job information.

Meanwhile, Request for Comments (RFC) 8011 and Printer Working Group (PWG) prescribe a method for specifying a privacy setting for a print job according to printing standards without using vendor drivers. These standards use a print protocol called Internet Printing Protocol (IPP) to implement a privacy setting for a print job having an IPP-based format. In recent years, a method for performing IPP-based printing without using vendor drivers has been started to be used.

### CITATION LIST

### Patent Literature

PTL 1: Japanese Patent Application Laid-Open No. 2004-199409

When using a vendor driver of the same vendor as the vendor of the printing apparatus, only a predefined privacy setting can be specified, and printing can be performed with no mismatching with the security level of the printing apparatus. However, since a standard such as IPP prescribes a privacy setting that cannot be specified by vendor drivers, printing may possibly be performed with a mismatching with the security level of the printing apparatus.

### SUMMARY OF THE INVENTION

In view of the above-described issue, the present invention is directed to providing a printing apparatus with a mechanism for enabling Internet Printing Protocol (IPP)-based printing in a state where a suitable privacy setting is reflected in IPP-based printing.

To achieve at least one of the above-described objects, according to an aspect of the present invention, a printing apparatus including a printing unit configured to receive a print job having a format based on Internet Printing Protocol (IPP) from a client terminal and perform IPP-based printing based on the received print job, the printing apparatus includes an identification unit configured to identify a privacy attribute value that can be specified in IPP-based printing according to a privacy setting related to the print job having the IPP-based format, a response unit configured to issue at least a response for the privacy attribute value in response to a printing apparatus capability inquiry request received from the client terminal, and an access control unit configured to, upon reception of a print request having the IPP-based format including the privacy attribute value from the client terminal, perform access control on the print job based on the privacy attribute value of the print job.

Further features of the present invention will become apparent from the following description of exemplary embodiments with reference to the attached drawings.

### BRIEF DESCRIPTION OF THE DRAWINGS

FIG. 1 illustrates an example of a printing system.

FIG. 2 illustrates an example of a list of user information for a printing apparatus.

FIG. 3A illustrates an example of a job status check screen of the printing apparatus.

FIG. 3B illustrates another example of a job status check screen of the printing apparatus.

FIG. 3C illustrates still another example of a job status check screen of the printing apparatus.

FIG. 4 illustrates an example of a hardware configuration of the printing apparatus.

FIG. 5 illustrates an example of a privacy setting screen of a printing apparatus according to a first exemplary embodiment.

FIG. 6 is a sequence diagram illustrating an example of control by the printing apparatus according to the first exemplary embodiment.

FIG. 7 is a flowchart illustrating a capability response by the printing apparatus according to the first exemplary embodiment.

FIG. 8 is a flowchart illustrating print processing by the printing apparatus according to the first exemplary embodiment.

FIG. 9 is a flowchart illustrating processing for displaying a status check screen by the printing apparatus according to the first exemplary embodiment.

FIG. 10 illustrates an example of a job status check screen of the printing apparatus according to the first exemplary embodiment.

FIG. 11A illustrates an example of packet data related to a capability response according to the first exemplary embodiment.

FIG. 11B illustrates another example of packet data related to a capability response according to the first exemplary embodiment.

FIG. 11C illustrates still another example of packet data related to a capability response according to the first exemplary embodiment.

FIG. 11D illustrates still another example of packet data related to a capability response according to the first exemplary embodiment.

FIG. 12A illustrates an example of packet data related to a print request according to the first exemplary embodiment.

FIG. 12B illustrates another example of packet data related to a print request according to the first exemplary embodiment.

FIG. 12C illustrates still another example of packet data related to a print request according to the first exemplary embodiment.

FIG. 12D illustrates still another example of packet data related to a print request according to the first exemplary embodiment.

FIG. 12E illustrates still another example of packet data related to a print request according to the first exemplary embodiment.

FIG. 12F illustrates still another example of packet data related to a print request according to the first exemplary embodiment.

FIG. 13 illustrates an example of a privacy setting screen of a printing apparatus according to a second exemplary embodiment.

FIG. 14 is a flowchart illustrating processing for displaying a status check screen by the printing apparatus according to the second exemplary embodiment.

FIG. 15 is a flowchart illustrating a capability response by a printing apparatus according to a third exemplary embodiment.

FIG. 16 is a flowchart illustrating print processing by a printing apparatus in a fourth exemplary embodiment.

FIG. 17A illustrates an example of packet data related to a capability response according to a fifth exemplary embodiment.

FIG. 17B illustrates another example of packet data related to a capability response according to the fifth exemplary embodiment.

FIG. 17C illustrates still another example of packet data related to a capability response according to the fifth exemplary embodiment.

FIG. 17D illustrates still another example of packet data related to a capability response according to the fifth exemplary embodiment.

### DESCRIPTION OF THE EMBODIMENTS

Exemplary embodiments of the present invention will be described below with reference to the accompanying drawings. The following exemplary embodiments do not limit the present invention within the scope of the appended claims. Not all of the combinations of the features described in the exemplary embodiments are indispensable to the solutions for the present invention.

### First Exemplary Embodiment

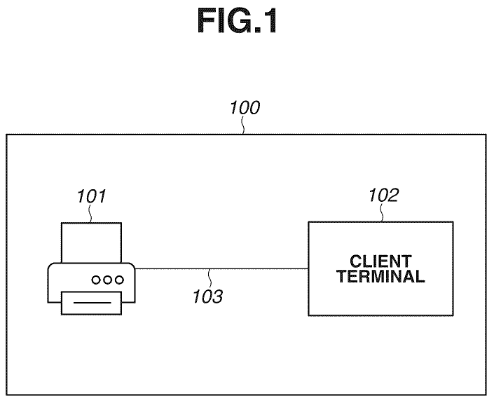

A configuration of a printing system of the present invention will be described below with reference to FIG. 1. A printing system 100 according to the first exemplary embodiment includes a printing apparatus 101 and a client terminal 102. The printing apparatus 101 communicates with the client terminal 102 via a network 103.

The network 103 may be configured by a combination of communication networks such as a Local Area Network (LAN) and a Wide Area Network (WAN), communication based on a Universal Serial Bus (USB), a cellular network of Long Term Evolution (LTE), 5th Generation (5G), or the like, and a wireless network conforming to Institute of Electrical and Electronics Engineers (IEEE) 802.11. More specifically, any communication method of the physical layer is applicable as long as the network 103 is able to perform data communication.

The printing apparatus 101 has a scanning function of reading an image by using a scanner and transmitting the image-based data to an external apparatus, a printing function of printing an image on a sheet such as paper based on a print job received from an external apparatus, and a copy function.

Although the present exemplary embodiment has been described above centering on a Multi Function Peripheral (MFP) having a plurality of functions as an example of a printing apparatus, the present invention is not limited thereto. For example, a Single Function Peripheral (SFP) having only a printing function is also applicable. Although the present exemplary embodiment will be described below centering on an example where printing is made on a sheet such as paper, the present exemplary embodiment is not limited thereto but is also applicable to printing control, for example, in three-dimensional (3D) printing of molding a solid object based on three-dimensional shape data.

The printing apparatus 101 according to the present exemplary embodiment includes print job storage areas. If print jobs are stored in a storage such as a hard disk drive (HDD) of the printing apparatus 101, the user can select a print job and perform print processing at any time.

The client terminal 102 has a function of transmitting print data to the printing apparatus 101. The user may install a vendor driver in the client terminal 102 and use the Internet Printing Protocol (IPP) function prepared in the client terminal 102. In recent years, client terminal operating systems (OS's) having pre-installed IPP-based printing functions, such as AirPrint® and Mopria®, have been widely used.

An issue of IPP-based printing in a case of printing a privacy job by using IPP will be described below. A print job in the IPP standard has a format that enables setting the job attributes of a document. More specifically, the format defines the “Document-Privacy-Attributes” attribute indicating the range of the job attributes, and the “Document-Privacy-Scope” attribute indicating the user who can access the job attributes. The following setting values are defined for the “Document-Privacy-Attributes” attribute and the “Document-Privacy-Scope” attribute.

TABLE 1

| Attribute | Setting value | Contents |
|---|---|---|
| document-privacy- | All | All attributes other than Document-job-id, document-job-uri, |
| | | document-number, document-printer-uri, and document-uuid are |
| | | private |
| attributes | default | All of Document Description and Document Template attributes are |
| | | private |
| | document- | All of Document Description attributes are private |
| | description | |
| | document-template | All of Document Template attributes are private |
| | none | No private attribute |
| document-privacy- | all | All users can access private attributes |
| scope | default | Document owner and operator/administrator can access private |
| | | attributes |
| | owner | Only document owner can access private attributes |
| | none | All users can access private attributes |

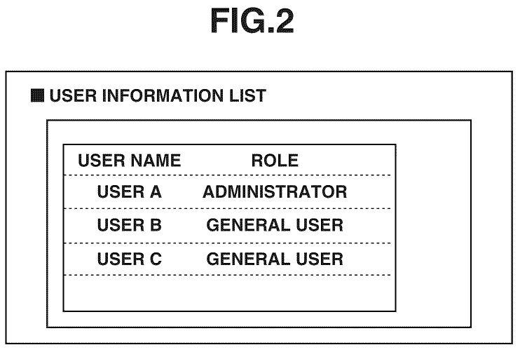

The printing apparatus 101 may set a role for each user as illustrated in FIG. 2 to manage the users. For example, a user A as an administrator has the right to change all setting values of the printing apparatus 101 and refer to and operate all print jobs. Users B and C as general users do not have the right to change the administrator setting values of the printing apparatus 101 and operate jobs of other users but have only the right to operate their own print jobs. If the privacy attribute value is “owner” or “default” indicating that some users cannot access job attributes, the printing apparatus 101 performs access control based on the role and/or the user name of the print requester of the printing apparatus 101. A form of access control according to the present invention will be described below.

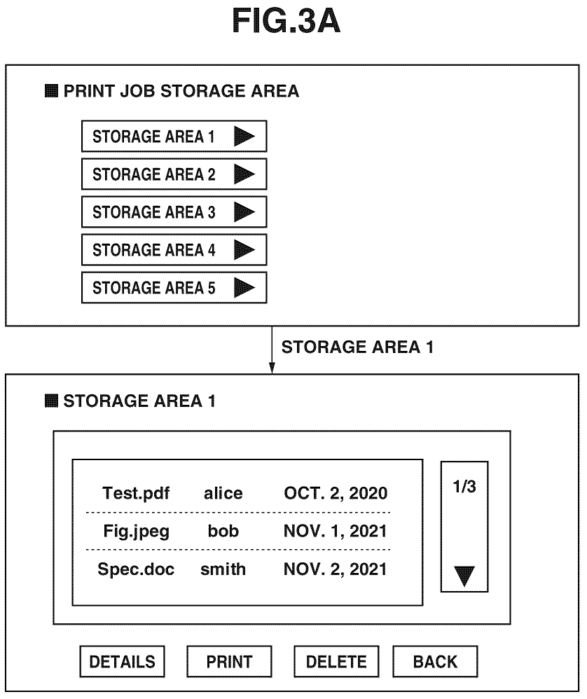

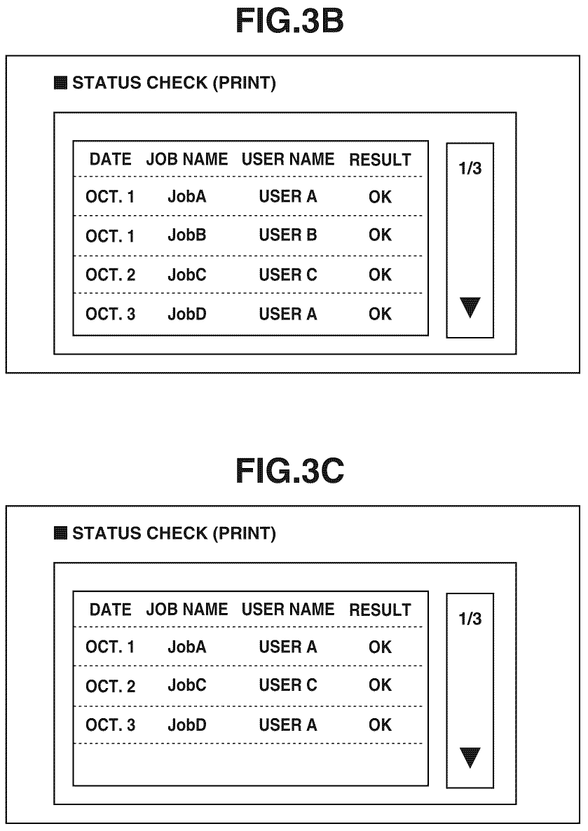

FIGS. 3A to 3C illustrate print job status check screens of the printing apparatus 101, displaying a list of print jobs received by the printing apparatus 101. If the privacy setting is made for none of print jobs (“Document-Privacy-Attributes” is set to “none”), all of the users A, B, and C can refer to the status check screen to access the job attributes including print jobs (information acquisition). Thus, the job history of all the users can be entirely displayed, as illustrated in FIG. 3A.

However, for example, if the print job of the user B is subjected to a privacy setting “default” for the “Document-Privacy-Attributes” attribute and a privacy setting “owner” for the “Document-Privacy-Scope” attribute, only the user B as a document owner can access the job attributes of this print job.

Therefore, if the user B refers to the status check screen, the screen displays the job history of all the users, as illustrated in FIG. 3B. If a user other than the user B refers to the status check screen, the screen displays a job list not including a job B as illustrated in FIG. 3C since the user cannot access (acquire information about) the job attributes of the job B transmitted by the user B.

For the management of the printing apparatus 101, the administrator may want to refer to when printing has been performed, who has performed printing, and what data printing has been performed. If the job B is suspended because of an error during discharge processing, the administrator may stop the job B in place of the user B. However, there has been an issue that, if an IPP privacy attribute value is unsuitably specified, the administrator cannot suitably manage print jobs.

### <Hardware Configuration of Printing Apparatus 101>

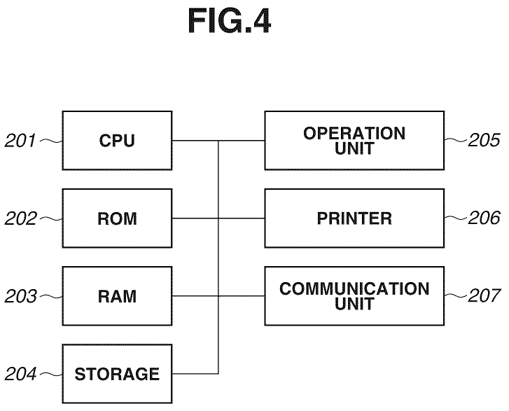

A hardware configuration of the printing apparatus 101 according to the present exemplary embodiment will be described below with reference to FIG. 4. FIG. 4 is a block diagram illustrating the hardware configuration of the printing apparatus 101. The printing apparatus 101 has a reading function of reading an image on a sheet, and a file transmission function of transmitting the read image to an external communication apparatus. The printing apparatus 101 also has a printing function of printing an image on a sheet, another printing function of receiving a print job from the client terminal 102 and performing printing, the above-described user management function, and a reservation printing function.

A Central Processing Unit (CPU) 201 controls overall operations of the printing apparatus 101. The CPU 201 reads a control program stored in a Read Only Memory (ROM) 202 or a storage 204 and then performs printing control, reading control, and other various types of control. The ROM 202 stores control programs executable by the CPU 201. A Random Access Memory (RAM) 203 is the main memory accessed by the CPU 201 and is used as a work area or a temporary storage area for loading various control programs. The storage 204 stores print jobs, image data, various programs, and various kinds of setting information. The hardware components including the CPU 201, the ROM 202, the RAM 203, and the storage 204 configure what is called a computer.

Although, in the printing apparatus 101 according to the present exemplary embodiment, one CPU 201 executes each piece of processing illustrated in flowcharts (described below) by using one memory (RAM 203), other configurations are also applicable. For example, a plurality of processors, a plurality of memories, or a plurality of storages may be cooperatively operated to perform each piece of processing illustrated in flowcharts (described below). The above-described processing may be partly executed by hardware circuitry.

A printer 206 prints an image on a sheet supplied from a sheet cassette (not illustrated), based on input print images and print control commands. Applicable printing methods include an electrophotographic process in which a toner is transferred onto a sheet and then fixed, and an ink-jet method in which ink is discharged onto a sheet.

The operation unit 205 is provided with a Liquid Crystal Display (LCD) having a touch panel function, and various hardware keys. The operation unit 205 functions as a display unit for displaying information to the user and a reception unit for receiving user instructions. The CPU 201 controls information display and user operation reception in collaboration with the operation unit 205.

The communication unit 207 is connected with a network cable to communicate with an external apparatus on the network 103 and the Internet. Although the present exemplary embodiment assumes that the communication unit 207 is a communication interface for performing wire communication conforming to Ethernet*, the present invention is not limited thereto. For example, the communication unit 207 may be a wireless communication interface conforming to IEEE 802.11 Series. Both the communication unit 207 and the external apparatus may be wireless communication interfaces. The communication unit 207 may also perform mobile communication including 3rd Generation (3G) communication such as Code Division Multiple Access (CDMA), 4th Generation (4G) communication such as LTE, and 5th Generation New Radio (5G NR) communication.

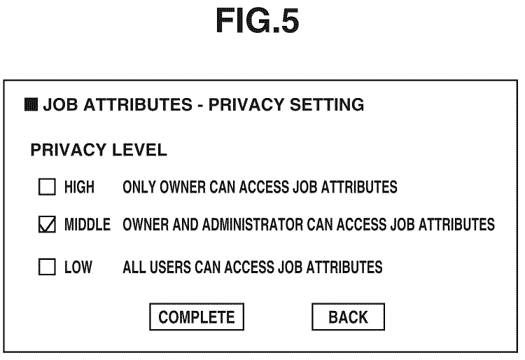

FIG. 5 illustrates an example of a privacy setting screen for the job attributes of the printing apparatus 101. The privacy level can be selected from “High” “Middle” and “Low”. The “High” privacy level allows only the document owner who has entered a print job to access the job attributes of the print job. The “Middle” privacy level allows the document owner and the administrator who has entered a print job to access the job attributes of the print job. The “Low” privacy level allows all the users to access the job attributes of the print job.

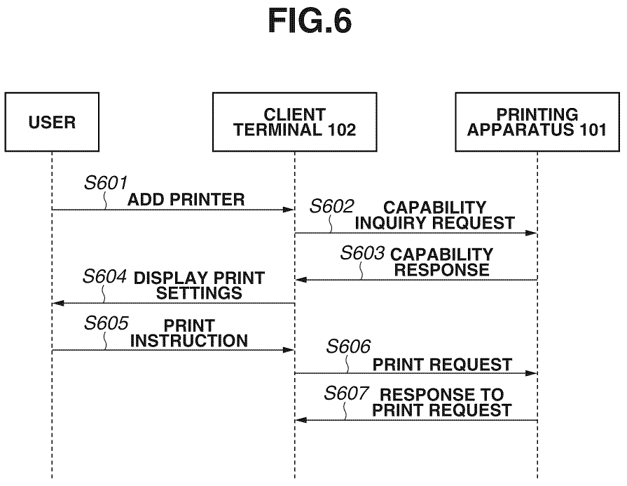

A sequence of a print job according to the present exemplary embodiment will be described below with reference to FIG. 6. Firstly, the user performs a printer generation operation of the printing apparatus 101 by using the client terminal 102. Although the printer generation operation differs according to the OS, the user generally performs a printer search operation from a printer setting screen. When the client terminal 102 receives a printer generation instruction from the user, the client terminal 102 searches for printing apparatuses existing on the network and displays a list of detected printing apparatuses. In step S601, the user selects one desired printing apparatus from the list of printing apparatuses and adds the printer.

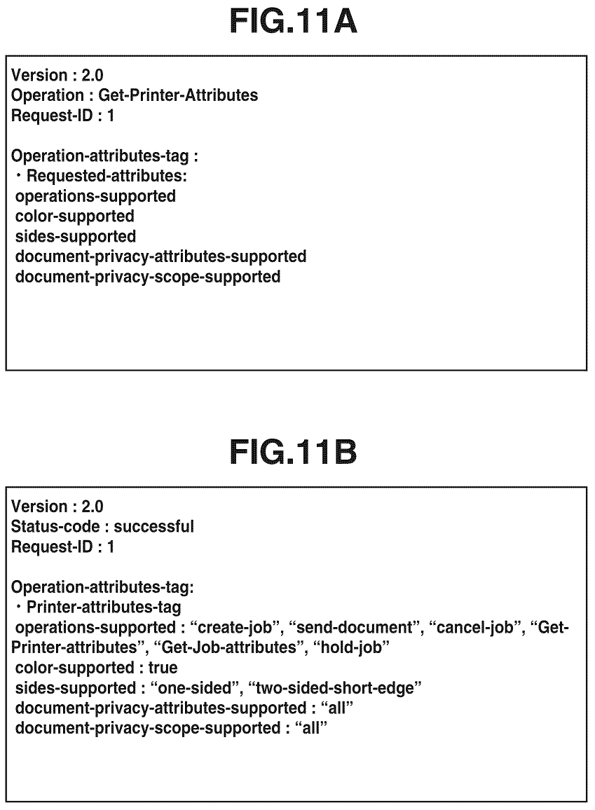

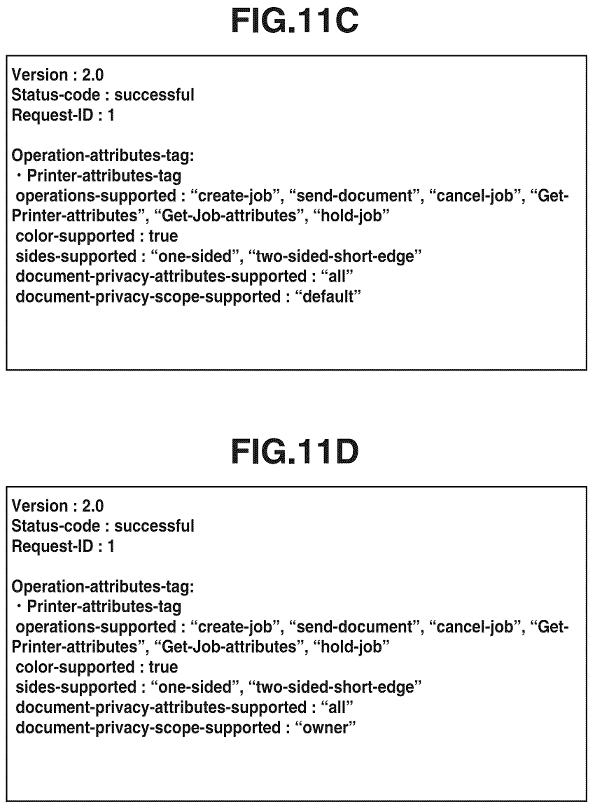

Upon reception of a printer addition instruction, then in step S602, the client terminal 102 transmits a detailed capability inquiry request to the specified printing apparatus based on IPP. FIG. 11A illustrates an example of a packet for making an inquiry about the capability of the printing apparatus 101 by using the IPP-based Get-Printer-Attributes operation. In this packet, “Document-Privacy-Attributes” makes an inquiry about the job attributes subjected to the privacy setting and “Document-Privacy-Scope” makes an inquiry about what kind of privacy setting is made.

Upon reception of the capability inquiry request, then in step S603, the CPU 201 of the printing apparatus 101 transmits a capability response packet to the client terminal 102 based on IPP. When the “Low” privacy level is set for the privacy setting in FIG. 5, the printing apparatus 101 stores a privacy attribute value “all” in “Document-Privacy-Scope” illustrated in FIG. 11B and then issues a response. When the “Middle” privacy level is set for the privacy setting, the printing apparatus 101 stores a privacy attribute value “default” in “Document-Privacy-Scope” illustrated in FIG. 11C and then issues a response. When the “High” privacy level is set for the privacy setting, the printing apparatus 101 stores a privacy attribute value “owner” in “Document-Privacy-Scope” illustrated in FIG. 11D and then issues a response. This enables notifying the client terminal 102 of information about the privacy setting of the printing apparatus 101 based on IPP. The printing apparatus 101 holds mapping information that associates the privacy setting with the privacy setting value (according to the first exemplary embodiment, the privacy level has been described as an example of the privacy setting).

Upon reception of the capability response from the printing apparatus 101, then in step S604, the client terminal 102 displays the print screen setting according to the received capability. In step S605, the user selects a desired print setting and then performs a printing operation. The print setting items and candidates of print setting values are displayed in the print setting screen according to the received capability response from the printing apparatus 101. However, the privacy attribute value may not be displayed to prevent user operations.

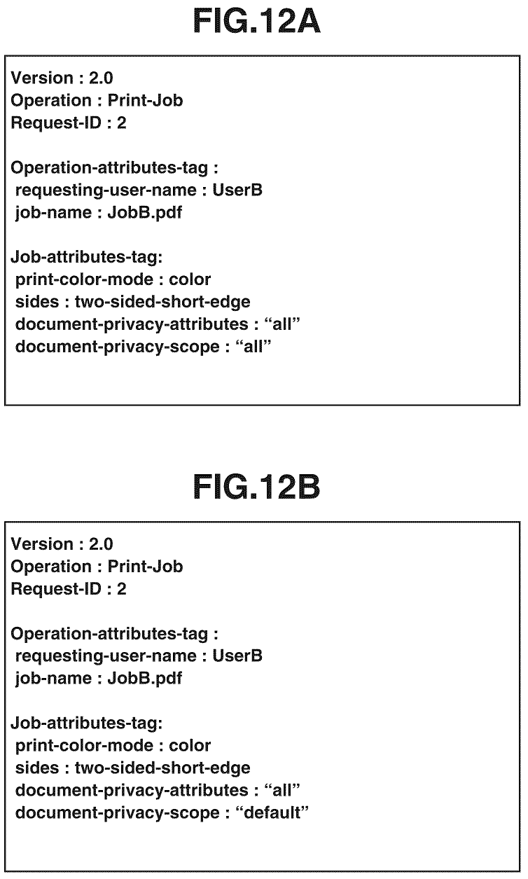

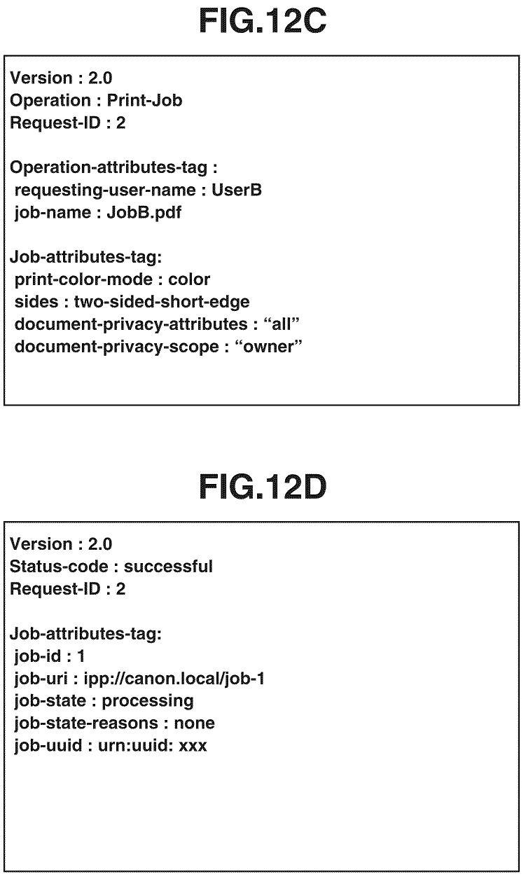

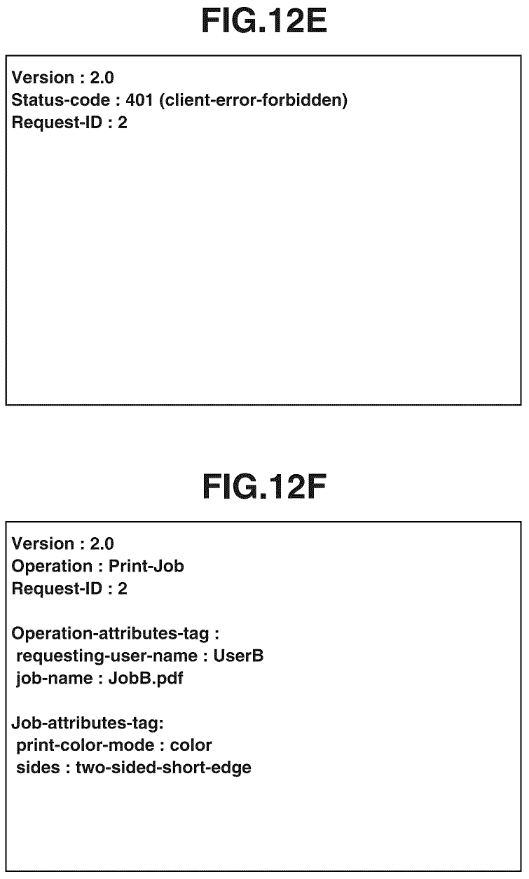

Upon reception of a printing instruction, then in step S606, the client terminal 102 transmits print data having an IPP-based format according to the specified print setting to the printing apparatus 101. FIG. 12A illustrates an example of a print request packet in which “all” is specified for “Document-Privacy-Scope”. The capability response in FIG. 11B issued by the printing apparatus 101 means that the printing apparatus 101 supports only the “all” privacy setting. Therefore, if the client terminal 102 specifies “Document-Privacy-Scope”, “all” is specified without exception. Likewise, FIG. 12B illustrates an example of a print request packet in which “default” is specified for “Document-Privacy-Scope”. FIG. 12C illustrates an example of a print request packet in which “owner” is specified for “Document-Privacy-Scope”.

Upon reception of the print request, the CPU 201 of the printing apparatus 101 performs print processing according to the specified privacy setting of the received print job and then issues a success response illustrated in FIG. 12D to the client terminal 102. If the CPU 201 fails in response to the print request, the CPU 201 issues a failure response illustrated in FIG. 12E. If the user performs IPP-based printing without performing the privacy setting at issuance of a print request, the client terminal 102 issues a print request without specifying “Document-Privacy-Scope” and “Document-Privacy-Attributes” as illustrated in FIG. 12F.

The IPP security setting defines “Document-Privacy-Scope” that can be set on a document basis, and also defines “Job-Privacy-Scope” that can be set on a job basis. “Job-Private-Scope” defines setting values similar to those in the above-described “Document-Privacy-Scope”. Therefore, also for “Job-Privacy-Scope”, the settings to be stored may be changed in association with the settings in FIG. 5.

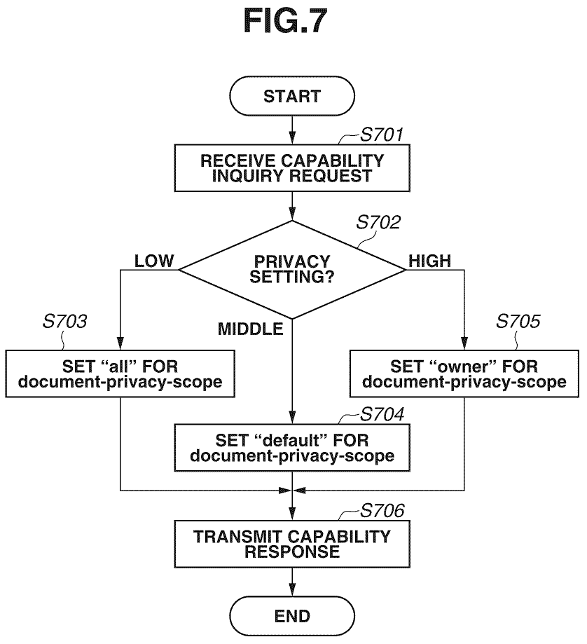

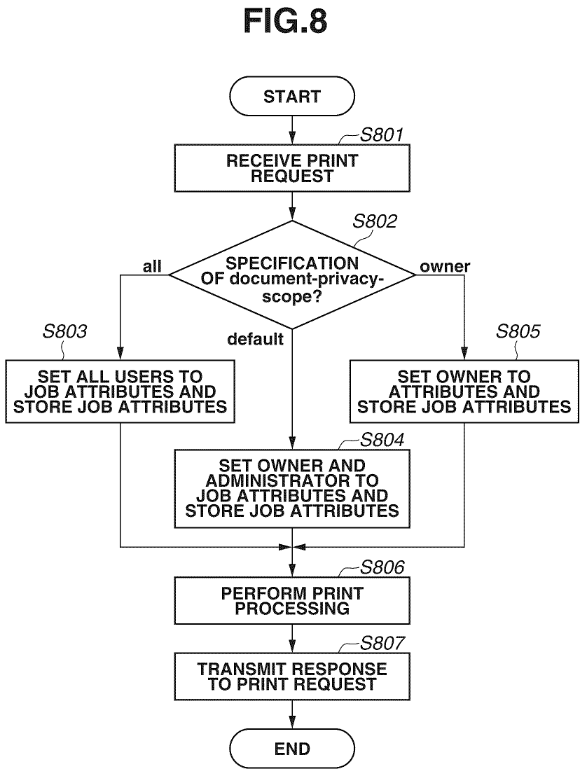

The operations of the CPU 201 of the printing apparatus 101 in issuing a capability inquiry by the printing apparatus 101 will be described below with reference to the flowcharts in FIGS. 7, 8, and 9. In step S701, the CPU 201 receives a capability inquiry request from the client terminal 102 (this step corresponds to step S602). Upon reception of the request, then in step S702, the CPU 201 determines the detail of the response according to the privacy setting of the job attributes of the printing apparatus 101. If the “Low” privacy level is set for the privacy setting (LOW in step S702), the processing proceeds to step S703. In step S703, the CPU 201 stores an attribute value “all” in “Document-Privacy-Scope”. If the “Middle” privacy level is set for the privacy setting (MIDDLE in step S702), the processing proceeds to step S704. In step S704, the CPU 201 stores an attribute value “default” in “Document-Privacy-Scope”. If the “High” privacy level is set for the privacy setting (HIGH in step S702), the processing proceeds to step S705. In step S705, the CPU 201 stores an attribute value “owner” in “Document-Privacy-Scope”. In step S706, the CPU 201 transmits one of the capability response packets illustrated in FIGS. 11B, 11C, and 11D to the client terminal 102.

In step S801, the CPU 201 receives a print request from the client terminal 102 (this step corresponds to S606). Upon reception of the request, then in step S802, the CPU 201 determines the detail of processing according to the privacy setting specified in the print request.

If “all” is specified for “Document-Privacy-Scope” as illustrated in FIG. 12A (“all” in step S802), the processing proceeds to step S803. In step S803, the CPU 201 make setting so that all the users can access the job attributes of the received print job. The CPU 201 stores the set job attribute values of the print job in the storage 204.

If “default” is specified for “Document-Privacy-Scope” as illustrated in FIG. 12B (“default” in step S802), the processing proceeds to step S804. In step S804, the CPU 201 makes setting so that only the document owner and the administrator who has entered the print job can access the job attributes of the received print job. The CPU 201 determines the document owner based on the user name specified with “Requesting-user-name” included in the print request packet and the user name authenticated by the BASIC, DIGEST, or OAUTH authentication. The job attributes of an IPP print job refer to a state where the user-set setting values are reflected. According to the first exemplary embodiment, the privacy attribute value is also included in the job attributes regardless of whether the user can set the privacy attribute value.

If “owner” is specified for “Document-Privacy-Scope” as illustrated in FIG. 12C (“owner” in step S802), the processing proceeds to step S805. In step S805, the CPU 201 makes setting so that only the document owner who has entered the print job can access the job attributes of the received print job. In step S806, the CPU 201 performs print processing for the received print data by using the printer 206. In step S807, the CPU 201 transmits a print processing success response illustrated in FIG. 12D to the client terminal 102 (this step corresponds to step S607).

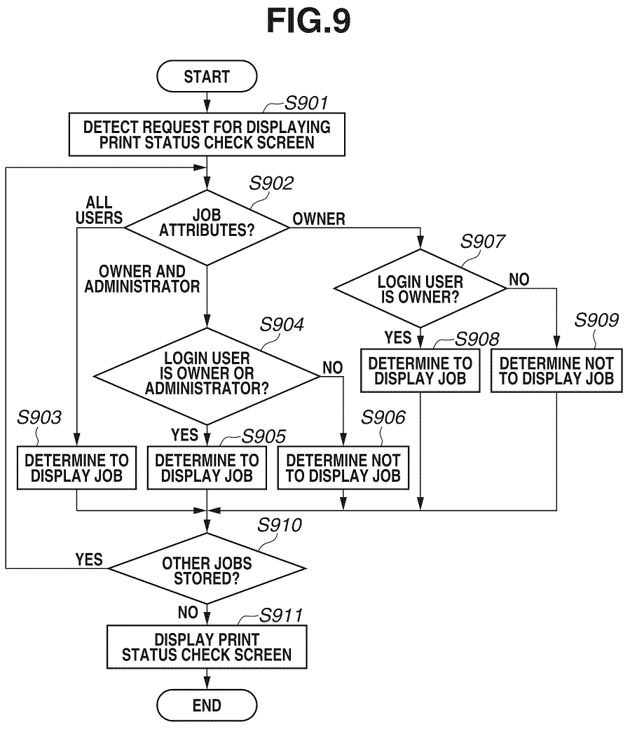

FIG. 9 is a flowchart illustrating processing performed by the CPU 201 to display the status check screen of the printing apparatus 101. In step S901, the CPU 201 detects the reception of a request to display the printing status check screen from the user via the operation unit 205. Upon detection of the request, then in step S902, the CPU 201 checks each of the job attributes of the print job stored in the storage 204 and then determines whether to display or hide a target job. If setting is made so that all the users can access the job attributes of the target job (ALL USERS in step S902), the processing proceeds to step S903. In step S903, the CPU 201 determines to display the target job.

If setting is made so that only the owner and the administrator can access the job attributes (OWNER AND ADMINISTRATOR in step S902), the processing proceeds to step S904. In step S904, the CPU 201 determines whether the operation requester is the owner or the administrator. More specifically, if the operation requester operating the printing apparatus 101 logs into the printing apparatus 101, the CPU 201 checks the role and user name of the operation requester to identify whether the operation requester is the owner or the administrator. If the operation requester is the owner or the administrator (YES in step S904), the processing proceeds to step S905. In step S905, the CPU 201 determines to display the target job. If the operation requester is neither the owner nor the administrator (NO in step S904), the processing proceeds to step S906. In step S906, the CPU 201 determines not to display the target job.

If setting is made so that only the owner can access the job attributes (OWNER in step S902), the processing proceeds to step S907. In step S907, the CPU 201 determines whether the operation requester is the owner. When the operation requester is the owner (YES in step S907), the processing proceeds to step S908. In step S908, the CPU 201 determines to display the target job. When the operation requester is not the owner (NO in step S907), the processing proceeds to step S909. In step S909, the CPU 201 determines not to display the target job. In step S910, the CPU 201 determines whether other print job information is stored in the storage 204. If other print job information is stored (YES in step S910), the CPU 201 changes the target job to another job. Then, the processing returns to step S902. If no other print job information is stored (NO in step S910), the processing proceeds to step S911. In step S911, the CPU 201 displays the printing status check screen on the operation unit 205.

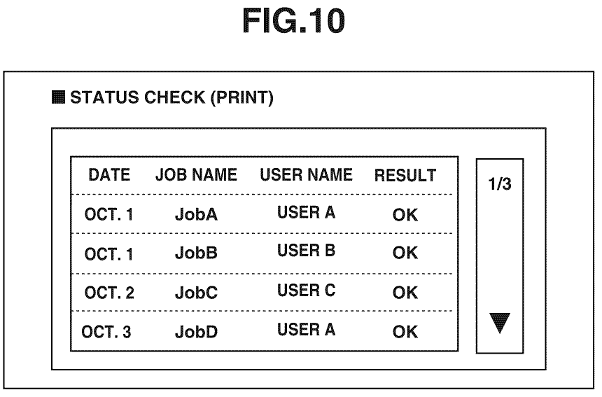

For example, the user B or C specifies “default” for “Document-Privacy-Scope” and enter a print job. If the user A having the administrator right refers to the printing status check screen, the user A can refer to the print job information for the users B and C in addition to the print job of the user A as illustrated in FIG. 10. The present exemplary embodiment has been described above centering on an example of the “Document-Privacy-Scope”attribute, similar control may also be performed with the “Job-Privacy-Scope” attribute.

By mapping privacy setting information for the printing apparatus 101 to the “Document-Privacy-Scope” attribute of IPP in this way, the CPU 201 can notify the client terminal 102 of a suitable privacy setting and perform print processing. This enables the user to obtain an equivalent effect to a vendor driver even by using IPP.

### Second Exemplary Embodiment

A second exemplary embodiment will be described below centering on a mechanism for limiting input of the privacy setting according to the authentication setting of the printing apparatus 101. The hardware configuration of each apparatus according to the second exemplary embodiment is similar to that according to the first exemplary embodiment. Differences from the first exemplary embodiment will be described below.

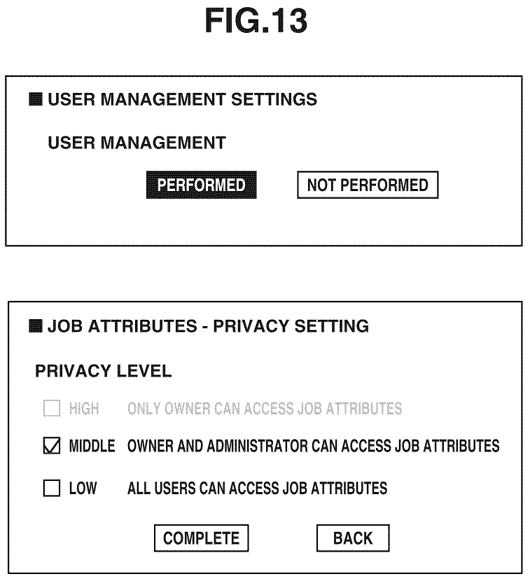

FIG. 13 illustrates examples of a user management setting screen and a privacy setting screen of the printing apparatus 101 according to the present exemplary embodiment. The user management setting screen enables the user management function to be “Performed” or “Not Performed” by the printing apparatus 101. If “Performed” is selected, the printing apparatus 101 sets the users and roles as illustrated in FIG. 2. When the user operates the operation unit 205 of the printing apparatus 101, the user needs to log into the printing apparatus 101. On the other hand, if “Not Performed” is selected, all the users do not need to log into the printing apparatus 101 and can perform all operations of the printing apparatus 101.

With the user management enabled, there exists an administrator user who manages the printing apparatus 101, and the administrator user needs to refer to and manage all print jobs. Therefore, with the user management enabled, if “owner” is specified for the “Document-Privacy-Scope” attribute of a print job, the administrator cannot access the print job. Therefore, if “Performed” is selected for “User Management”, the CPU 201 hides the “High” privacy level of the privacy setting or displays it in a gray-out state, as illustrated in FIG. 13, to disable setting. If there is an administrator user of the printing apparatus 101, the administrator can control all print jobs.

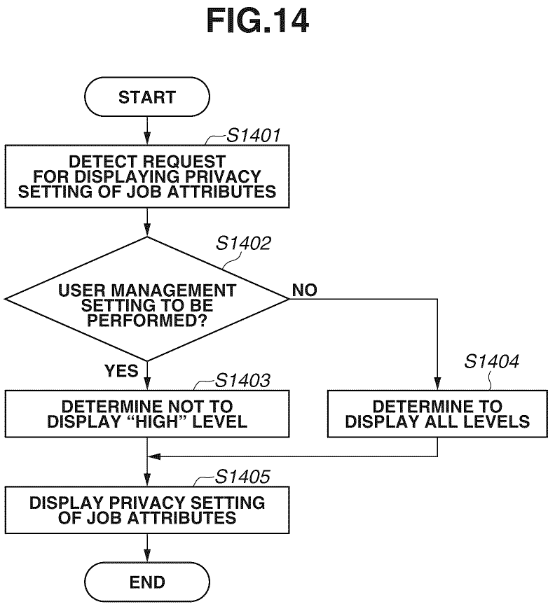

FIG. 14 is a flowchart illustrating processing performed by the CPU 201 to display the privacy setting. In step S1401, the CPU 201 detects the reception of a request to display the privacy setting. In step S1402, the CPU 201 refers to the user management setting and determines to control the display of the privacy setting. If “Performed” is selected for “User Management” (YES in step S1402), the processing proceeds to step S1403. In step S1403, the CPU 201 determines to hide the “High” privacy level of the privacy setting.

If “Not Performed” is selected for “User Management” (NO in step S1402), the processing proceeds to step S1404. In step S1404, the CPU 201 determines to display all privacy levels of the privacy setting. In step S1405, the CPU 201 displays the privacy setting screen as illustrated in FIG. 13 or 5. Control to hide the “High” privacy level has been described above. For example, if the setting “Performed” for “User Management” is changed in a state where the “High” privacy level of the privacy setting is displayed, the privacy level of the privacy setting may be automatically set to “Middle” in an associative way. More specifically, the privacy level of the privacy setting will be adjusted if “Performed” is selected for “User Management”. In a case where the user management is enabled, the above-described control enables preventing the occurrence of a print job that cannot be managed by the administrator, thus enabling suitable IPP-based job management.

### Third Exemplary Embodiment

A third exemplary embodiment will be described below centering on control in which the client terminal 102 ignores the setting of the “Document-Privacy-Scope” attribute included in the capability response from the printing apparatus 101 and specifies the value of the “Document-Privacy-Scope” attribute. The hardware configuration of each apparatus according to the third exemplary embodiment is similar to that according to the first exemplary embodiment. Differences from the first exemplary embodiment will be described below.

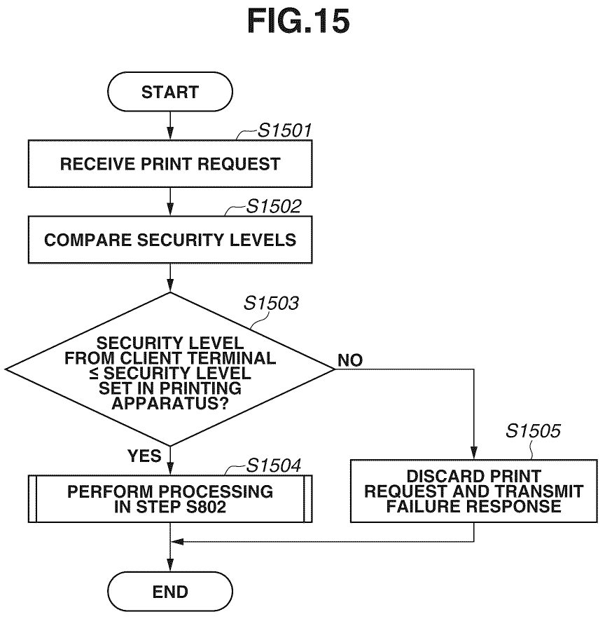

FIG. 15 is a flowchart illustrating processing performed by the CPU 201 upon reception of a print job according to the present exemplary embodiment. In step S1501, the CPU 201 receives a print request from the client terminal 102. In step S1502, the CPU 201 compares the value of the “Document-Privacy-Scope” attribute included in the print request with the level of the privacy setting set in the printing apparatus 101.

For example, assume that the printing apparatus 101 issues a capability response as illustrated in FIG. 11C. More specifically, the printing apparatus 101 has the “Middle” privacy level of the privacy setting and specifies “default” in the capability response. In this case, the client terminal 102 needs to specify “default” for the “Document-Privacy-Scope” attribute as illustrated in FIG. 12B and then issue a print request. However, the client terminal 102 may possibly specify “owner” as illustrated in FIG. 12C and then issue a print request. This case occurs if the client terminal 102 displays the private attribute value in the print setting screen, and the user changes the private attribute value. This case means that a security level higher than the security level set in the printing apparatus 101 has been specified from the client terminal 102.

In step S1503, the CPU 201 compares the security level of the privacy setting set in the printing apparatus 101 with the security level of the privacy setting included in the print request from the client terminal 102, and determines whether the latter security level is equal to or lower than the former security level. If the security level from the client terminal 102 is equal to or lower than the security level set in the printing apparatus 101 (YES in step S1503), the processing proceeds to step S1504. In step S1504, the CPU 201 normally continues the print processing. If the security level from the client terminal 102 is higher than the security level set in the printing apparatus 101 (NO in step S1503), the processing proceeds to step S1505. In step S1505, the CPU 201 discards the print request and transmits a failure response to the client terminal 102. The failure response may refer to, for example, a failure indicating “a request not permitted” with a status code 401, as illustrated in FIG. 12E.

If the client terminal 102 specifies an unsuitable privacy attribute value, the CPU 201 first compares the security levels in the printing apparatus 101, enabling suitable job management not to process a print job having an unsuitable privacy setting.

### Fourth Exemplary Embodiment

A fourth exemplary embodiment will be described below centering on control in which the client terminal 102 does not specify the “Document-Privacy-Scope” attribute. The hardware configuration of each apparatus according to the fourth exemplary embodiment is similar to that according to the first exemplary embodiment. Differences from the first exemplary embodiment will be described below.

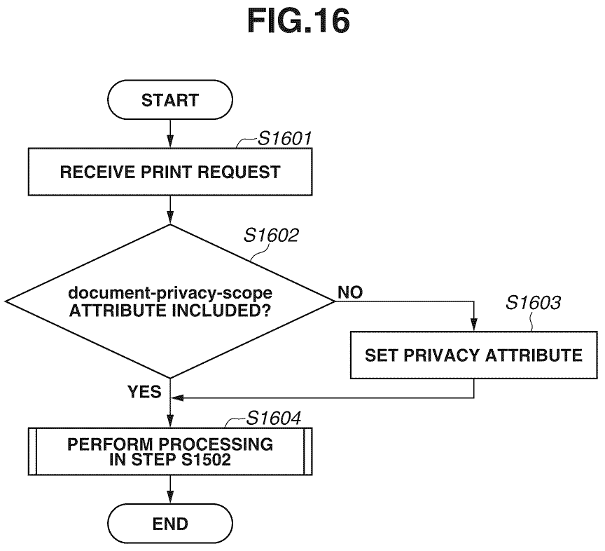

Even if the printing apparatus 101 issues a capability response for the privacy setting to the client terminal 102, a certain client terminal 102 may transmit a print request not including the “Document-Privacy-Scope” attribute as illustrated in FIG. 12D. FIG. 16 is a flowchart illustrating processing performed by the CPU 201 upon reception of such a print request. In step S1601, the CPU 201 receives a print request from the client terminal 102.

In step S1602, the CPU 201 determines whether the “Document-Privacy-Scope” attribute is included in the print request. If the “Document-Privacy-Scope” attribute is included in the print request as illustrated in FIGS. 12A, 12B, and 12C (YES in step S1602), the processing proceeds to step S1604. In step S1604, the CPU 201 performs print processing similar to that according to the first to third exemplary embodiments.

If the “Document-Privacy-Scope” attribute is not included in the print request as illustrated in FIG. 12D (NO in step S1602), the processing proceeds to step S1603. In step S1603, the CPU 201 refers to the value of the privacy setting of the printing apparatus 101 (see FIG. 5). If the “High” privacy level is set for the privacy setting of the printing apparatus 101, the CPU 201 internally applies the value “owner” of the “Document-Privacy-Scope” attribute to the received job attributes. If the “Middle” privacy level is set for the privacy setting of the printing apparatus 101, the CPU 201 internally applies the value “default” of the “Document-Privacy-Scope” attribute to the received job attributes. If the “Low” privacy level is set for the privacy setting of the printing apparatus 101, the CPU 201 internally applies the value “all” of the “Document-Privacy-Scope” attribute to the received job attributes. In step S1604, the CPU 201 performs print processing similar to that according to the above-described exemplary embodiments.

Even if the client terminal 102 does not specify the privacy attribute, the printing apparatus 101 applies the privacy attribute according to the privacy setting set therein, thus enabling suitable job management.

### Fifth Exemplary Embodiment

A fifth exemplary embodiment will be described below centering on control based on another determination method for determining the value of a capability response according to the privacy setting of the printing apparatus 101. The hardware configuration of each apparatus according to the fifth exemplary embodiment is similar to that according to the first exemplary embodiment. Differences from the first exemplary embodiment will be described below.

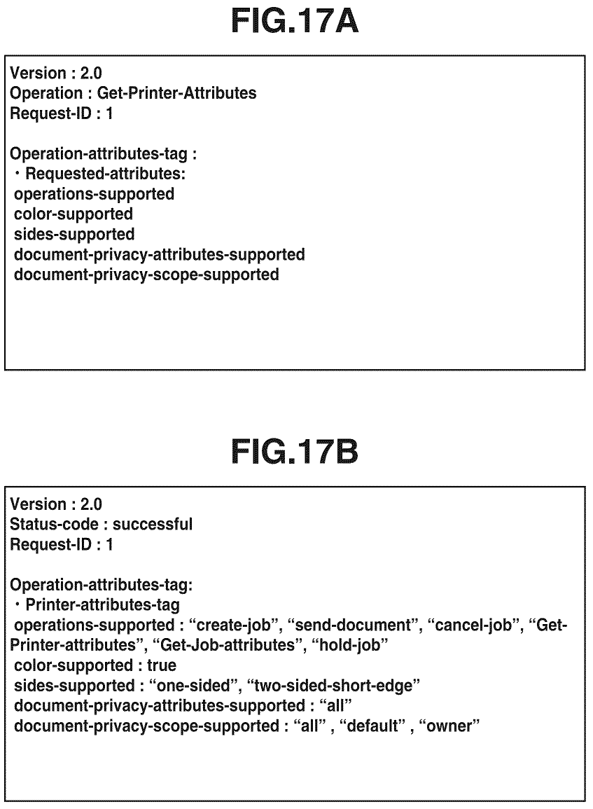

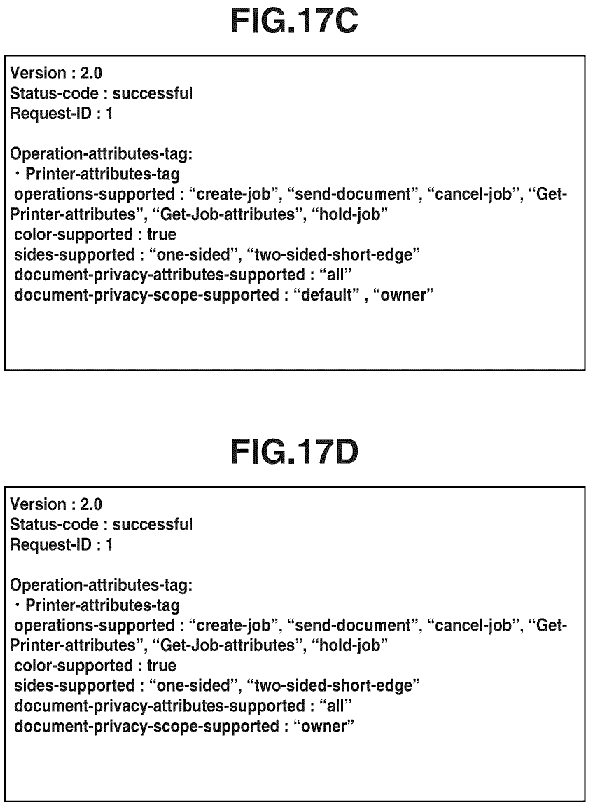

FIGS. 17A to 17D illustrate examples of packet data related to a capability response according to the fifth exemplary embodiment. FIG. 17A illustrates an example of a capability inquiry request received from the client terminal 102 by the printing apparatus 101. This request is equivalent to that according to the first exemplary embodiment.

FIGS. 17B, 17C, and 17D illustrate examples of capability response packet data issued by the printing apparatus 101 in response to the client terminal 102. According to the present exemplary embodiment, if the “Low” privacy level is set for the privacy setting of the printing apparatus 101, the CPU 201 stores three different values “all”, “default”, and “owner” in the “Document-Privacy-Scope” attribute as illustrated in FIG. 17B and then issue a response. This means that any of the three different values can be specified in the printing apparatus 101. Since the “Low” privacy level is set for the privacy setting, at least “all” needs to be specified. “default” or “owner” may also be specified.

If the “Middle” privacy level is set for the privacy setting of the printing apparatus 101, the CPU 201 stores “default” and “owner” in the “Document-Privacy-Scope” attribute as illustrated in FIG. 17C and then issue a response. If the “High” privacy level is set for the privacy setting of the printing apparatus 101, the CPU 201 stores only “owner” in the “Document-Privacy-Scope” attribute as illustrated in FIG. 17D and then issue a response. By issuing a capability response including a plurality of setting values, the user can select more suitable privacy setting and then perform printing.

### OTHER EXEMPLARY EMBODIMENTS

The present invention can also be achieved when a program for implementing at least one of the functions according to the above-described exemplary embodiments is supplied to a system or apparatus via a network or storage medium, and at least one processor in the computer of the system or apparatus reads and executes the program. Further, the present invention can also be achieved by a circuit (for example, an Application Specific Integrated Circuit (ASIC) and Field Programmable Gate Array (FPGA)) for implementing at least one function.

Further, when displaying the printing status check screen, the CPU 201 performs access control in which a certain job is displayed or hidden. However, in the access control, a certain job may be displayed in a gray-out state to be disabled while jobs subjected to access control are displayed.

The present invention is not limited to the above embodiments and various changes and modifications can be made within the spirit and scope of the present invention. Therefore, to apprise the public of the scope of the present invention, the following claims are made.

There is provided a printing apparatus with a mechanism for enabling IPP-based printing in a state where a suitable privacy setting is reflected in IPP-based printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A printing apparatus including a printing unit configured to receive a print job having a format based on Internet Printing Protocol (IPP) from a client terminal and perform IPP-based printing based on the received print job, the printing apparatus comprising:
an identification unit configured to identify a privacy attribute value that can be specified in IPP-based printing according to a privacy setting related to the print job having the IPP-based format;
a response unit configured to issue at least a response for the privacy attribute value in response to a printing apparatus capability inquiry request received from the client terminal; and
an access control unit configured to, upon reception of a print request having the IPP-based format including the privacy attribute value from the client terminal, perform access control on the print job based on the privacy attribute value of the print job.

2. The printing apparatus according to claim 1, wherein the identification unit identifies a privacy attribute value of IPP based on mapping information for associating a user-set privacy setting with a privacy setting value.

3. The printing apparatus according to claim 1, wherein, in a case where the privacy attribute value indicates a value indicating that some users cannot access, the access control unit performs access control based on a role and/or a user name of an operation requester of the printing apparatus.

4. The printing apparatus according to claim 1, wherein the access control performed by the access control unit refers to determining whether to display print jobs in a case where a printing status check screen is displayed.

5. The printing apparatus according to claim 1, wherein the privacy setting refers to a privacy level.

6. The printing apparatus according to claim 1, wherein the privacy attribute value refers to a value set for a Document-Privacy-Scope attribute in IPP.

7. The printing apparatus according to claim 1, further comprising a control unit configured to, in a case where the privacy attribute value is not included in a print request from the client terminal, perform the access control of the print job based on the privacy attribute value identified by the printing apparatus.

8. The printing apparatus according to claim 1, wherein a privacy setting related to a print job having the IPP-based format is changed according to a change of a user management setting.

9. The printing apparatus according to claim 1, wherein, upon reception of a print request having the IPP-based format including the privacy attribute value from the client terminal, in a case where the privacy attribute value included in the print request indicates a higher security level than the privacy attribute value in the response from the response unit, the printing apparatus discards the print request.
